(19) United States
(12) Patent Application Publication
(10) Pub. No.: US 2005/0266721 A1
(43) Pub. Date: Dec. 1, 2005

(54) Electrical connector with strain relief

(76) Inventors: John J. Milner, Madison, CT (US); Alan C. Miller, Madison, CT (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/854,036

(22) Filed: May 26, 2004

(51) Int. Cl. H01R 13/58

(52) U.S. Cl. 439/467

(57) ABSTRACT

A connector for a data communications system has a housing containing a printed circuit board. The printed circuit board has insulation displacement contacts for connecting with wires in a cable. The insulation displacement contacts are connected to nose contacts which are also mounted on the printed circuit board. The nose contacts form a channel between the nose contacts and the printed circuit board. A strain relief member is located in the channel. The strain relief member absorbs mating forces generated during connection and disconnection of the connector.

### FIELD OF THE INVENTION

The present invention relates to an electrical connector that meets high performance standards, particularly in high speed data transmissions. More specifically, the present invention relates to an electrical connector receivable in another mating connector that includes a housing, a strain relief member, a printed circuit board, nose contacts, and insulation displacement contacts that reduces near end crosstalk, thereby increasing performance to meet high performance standards, such as in category 6 applications.

### BACKGROUND OF THE INVENTION

Due to advancements in telecommunications and data transmission speeds over unshielded twisted wire pair cables, the connectors (such as jacks and plugs) have become critical impediments to high performance data transmission at high frequencies. Some performance characteristics, particularly near end crosstalk, degrade at higher frequencies in environments such as the Category 5e and Category 6 environments specified in the TIA/EIA-568-B series of commercial building cabling standards.

When electrical signals are carried on a signal line or wire which is in close proximity to another signal line or other signal lines, energy from one signal can be coupled into adjacent signal lines by the electrical field generated by the potential between the two signal lines and the magnetic field generated as a result of the changing electrical fields. This coupling, whether capacitive or inductive, is called crosstalk when the coupling occurs between two or more signal lines. Crosstalk is a noise signal and degrades the signal-to-noise (S/N) margin of a system. In communication systems, reduced S/N margin results in greater error rates in the information conveyed on the signal lines. Crosstalk generated at the connection between cables and connectors has become a significant problem.

Another significant problem with connectors is mechanical breakage of the connectors during installation and maintenance. A common type of connection in telecommunications and data networking is a connection between a cable and a 110 connection block. This connection comprises of a cable with a connector with female contacts and a connection block with male contacts. The connector is installed by pressing it onto the connection block. Friction forces between the pairs of mating contacts hold the connector in place.

This press-fit installation of the connectors to the connection block generates mating forces in the contacts in the connector. The mating forces can be substantial and can result in unacceptable loosening or breakage of joints (such as solder joints) in the connector. Removal of the connector generates similar forces in an opposite direction, and can result in the same unacceptable loosening or breakage. During the expected lifetime of a connector, it may be installed and removed numerous times, further compounding the potential damage caused by mating forces.

Damage can also be caused by improper usage of connectors. When removing a cable connector from a connection block, the user should grasp the housing of the connector and apply the removal force directly to the housing. In practice, however, connectors are often removed by pulling on the cable rather than the housing. This generates axial forces along the cable and causes strain in the connections between the cable and connector. This strain can result in undesirable breakage of the connection between the cable and the connector.

### SUMMARY OF THE INVENTION

An object of the present invention is to provide an electrical connector or cable for a communications systems which will reduce or not induce crosstalk in the system.

Another object of the present invention is to provide an electrical connector or a cable which will reduce potential breakage due to mating forces generated during connection or disconnection.

A further object of the present invention is to provide an electrical connector or cable which will reduce potential breakage due to axial loading forces on the cable.

Yet another object of the present invention is to provide an electrical connector which is simple and inexpensive to manufacture and use.

These objects are basically obtained by an electrical connector comprising a housing and a printed circuit board. The printed circuit board is contained within the housing. A plurality of insulation displacement contacts are mounted on the printed circuit board for connection to a cable. A plurality of nose contacts are also mounted on the printed circuit board. The nose contacts are configured to form a channel between the nose contacts and the printed circuit board, and a strain relief device is mounted within the channel. The strain relief device accepts mating forces and alleviates the strain on solder connections during connection and disconnection.

Other objects, advantages, and salient features of the present invention will become apparent from the following detailed description, which, taken in conjunction with the annexed drawings, discloses preferred embodiments of the invention.

### BRIEF DESCRIPTION OF THE DRAWINGS

Referring to the drawings which form a part of this disclosure:

FIG. 1 is a perspective view of an electrical connector according to the present invention;

FIG. 2 is a perspective view of the printed circuit board of FIG. 1 without the strain relief member for clarity;

FIG. 3 is a side elevational view in cross-section taken along line A-A of FIG. 2;

FIG. 4 is a perspective view of the printed circuit board of FIG. 1 with the strain relief member;

FIG. 5 is a side elevational view in cross-section taken along line B-B of FIG. 4;

FIG. 6 is a bottom view of the printed circuit board of FIG. 1;

FIG. 7 is a perspective view of a nose contact according to a second embodiment of the present invention;

FIG. 8 is a top view of the connector of FIG. 1 assembled with a cable;

FIG. 9 is a perspective view of a variation of the electrical connector of FIG. 1; and

FIG. 10 is a perspective view of a variation of the electrical connector of FIG. 1.

### DETAILED DESCRIPTION OF THE INVENTION

Referring initially to FIG. 1, an electrical connector 20 according to the present invention comprises a housing 22 having a cable connection end 24 and a contact end 26 at the opposite longitudinal ends of the housing. A printed circuit board 28 is contained within the housing 22. A plurality of insulation displacement contacts 30 and nose contacts 32 are mounted on the printed circuit board and are electrically connected by circuit traces on the printed circuit board 28. A strain relief member 60 is mounted in a channel 58 defined by the nose contacts and circuit board.

Housing 22 comprises a housing top 34 and a housing bottom 36. In the illustrated embodiment, the housing top 34 and housing bottom 36 are connected by a living hinge 38. The living hinge allows the housing top and bottom to move from an open position illustrated in FIG. 1 to a closed position (not illustrated). The halves may be held closed by mechanical engagement, sonic welding, or any other method known to those in the art. On the cable connection end 24, the housing top 34 has a recess 40 and the housing bottom 36 has a corresponding recess 42. When the housing is closed, the recesses 40, 42 form a cable pathway 44 to allow a cable to enter the housing. The configuration of housing 22, including the position of the nose contacts 32 at the contact end 26, conforms to standard connector geometry and pin out definitions for communications systems. Housing 22 is particularly suitable for use with 110 termination blocks used in the wiring industry.

The recesses 40, 42 provide strain relief for a cable passing through the cable pathway 44 by absorbing axial loading forces applied to a cable located within the recess. This strain relief may be accomplished by sizing the recesses 40, 42 to provide a friction fit between the recesses and a cable jacket. Alternatively, as illustrated in FIG. 9, the strain relief may be accomplished by applying an adhesive 82 to the recesses 40, 42 to form an adhesive connection between the recesses and a cable jacket, or as illustrated in FIG. 10, by providing piercing members 84 in the recesses to pierce a cable jacket. In this manner, when axial forces are applied to the cable, the forces are transferred to the housing 22 rather than to the connection between the insulation displacement contacts 30 and the individual wires connected thereto.

Adjacent the contact end 26, the housing 22 contains printed circuit board 28. As known to those skilled in the art, the insulation displacement contacts 30 are typically contained within a separate plastic housing, which is not shown here for the sake of clarity. The printed circuit board 28 may be fastened to the housing permanently or may be detachable. A detachable board allows replacing the printed circuit board to upgrade the connector to meet different performance requirements.

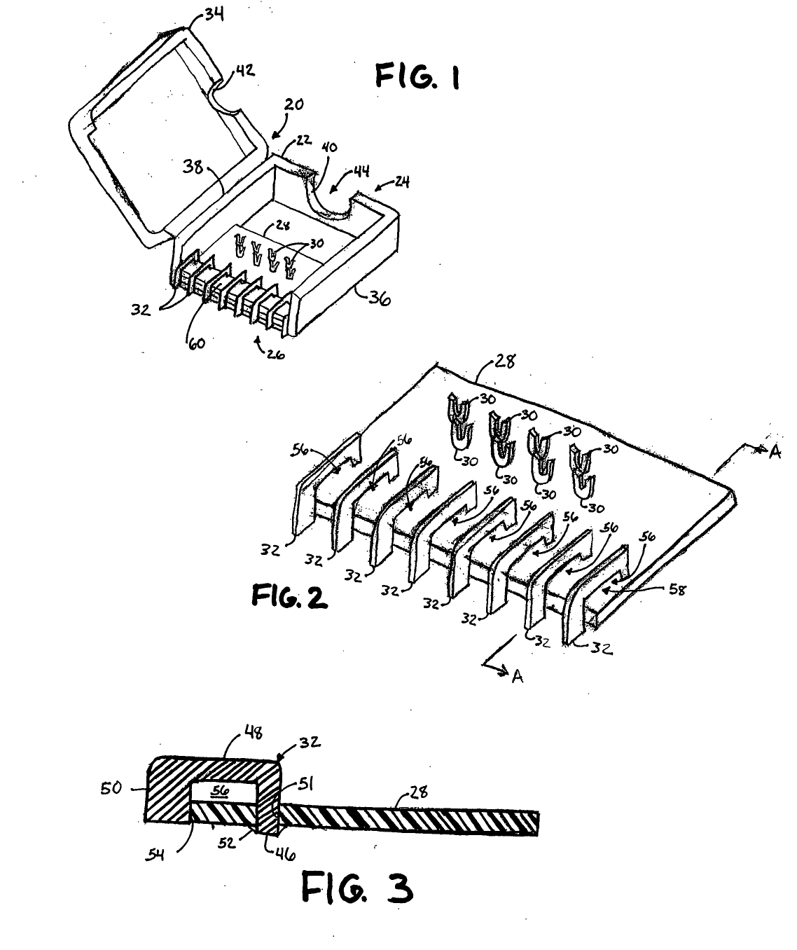

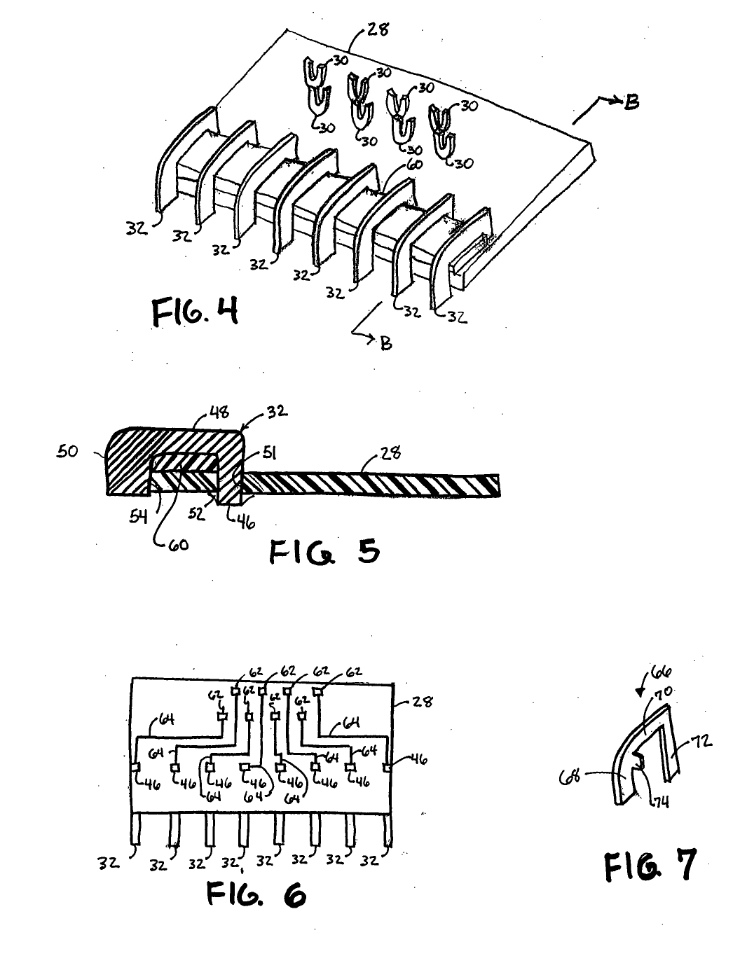

Referring now to FIG. 3, each nose contact 32 is generally U-shaped, with a solder tail 46, a connector portion 48, and a contact portion 50. Each solder tail 46 extends through an opening 51 in the printed circuit board 28 and is soldered to the printed circuit board by solder 52. The contact portions 50 extend past the edge 54 of the printed circuit board 28 so that the contact portions may interface with a connection block, which is not illustrated here. Each of the nose contacts 32 forms an opening 56 located between each nose contact and the printed circuit board. Together, these openings 56 form a channel 58 that is sized to receive a strain relief member 60. For clarity, the strain relief member is illustrated in FIGS. 4-5, but is not illustrated in FIGS. 2-3.

FIGS. 4-5 show the printed circuit board 28 with the strain relief member 60 in place. The strain relief member 60 is a generally rectilinear bar and is formed from any suitable dielectric material, such as plastic. The strain relief member abuts the nose contacts 32 or the nose contacts may be partially embedded in the strain relief member. The strain relief member may be fastened to the printed circuit board 28, fastened to the housing 22, or may float free. When the electrical connector 20 is pushed onto a connecting block, the mating forces produced on the nose contacts 32 are transferred to the strain relief member 60. This alleviates strain on the solder connections between the solder tails 46 of the nose contacts 32 and the printed circuit board 28.

Referring now to FIG. 6, the solder tails 46 of the nose contacts 32 and the solder tails 62 of the insulation displacement contacts 30 extend through the printed circuit board 28 and are soldered to the printed circuit board. Each nose contact 32 is connected to a corresponding insulation displacement contact by a circuit trace 64. The circuit traces 64 are configured on the printed circuit board 28 in a pattern that minimizes and/or reduces return loss and near end crosstalk noise. The pattern of the circuit traces (e.g. length, separation, thickness, and width) can be determined by software simulation, trial and error, or a combination of the two methods. U.S. Pat. No. 6,057,743, which is hereby incorporated by reference in its entirety, discloses an example of a noise reduction circuit formed on a printed circuit board.

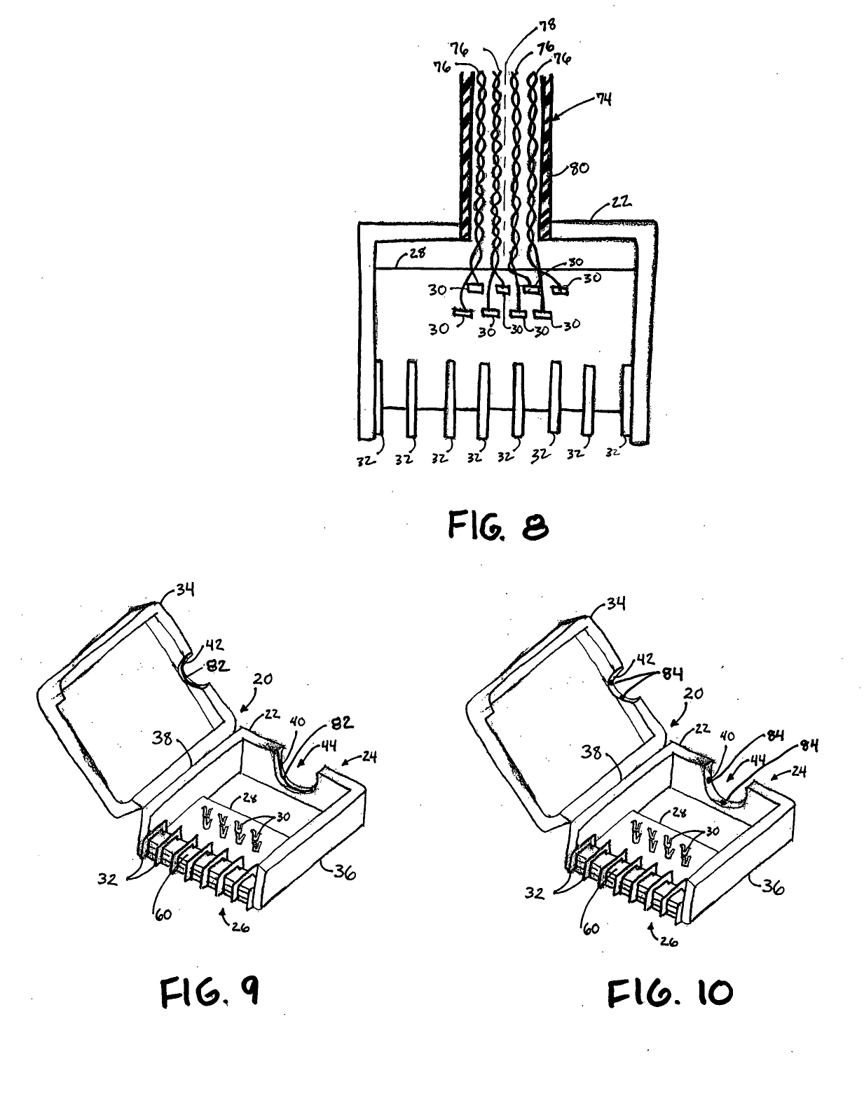

A nose contact 66 according to a second embodiment of the present invention is illustrated in FIG. 7. The nose contact comprises a contact portion 68, a connector portion 70, and a solder tail 72, which are located in the same general plane. A tab 74 extends from joint between the contact and connector portions and extends perpendicular to the plane formed by the contact portion 68, connector portion 70, and solder tail 72. When placed in the housing 22, the tab 74 abuts the strain relief member 60 and assists in the transmission of forces from the nose contact 66 to the strain relief member 60.

FIG. 8 shows the connector of the present invention fastened to an unshielded twisted wire pair cable 74. The cable 74 has four twisted wire pairs 76 that extend along a generally longitudinal axis 78. The twisted wire pairs 76 are surrounded by a flexible insulation sheath 80. The cable 74 passes through the cable pathway 44 in the housing 22. Each wire within the cable 74 is connected to a corresponding insulation displacement contact 30 in a conventional manner.

While various embodiments have been chosen to illustrate the invention, it will be understood by those skilled in the art that various changes and modifications can be made therein without departing from the scope of the invention as defined in the appended claims.

1. An electrical connector, comprising:
a housing;
a printed circuit board contained within said housing;
a plurality of insulation displacement contacts mounted on said printed circuit board;
a plurality of nose contacts mounted on said printed circuit board, said nose contacts forming a channel between said nose contacts and said printed circuit board; and
a relatively rigid strain relief member mounted within said channel formed by said nose contacts and said printed circuit board.

2. An electrical connector according to claim 1 wherein
said housing comprises a top half and a bottom half, said top half and bottom half being connected by a living hinge.

3. An electrical connector according to claim 2 wherein
said top half and bottom half have recesses forming a cable pathway.

4. An electrical connector according to claim 3 wherein
said recesses are coated with adhesive.

5. An electrical connector according to claim 3 wherein
said recesses form an interference fit with a cable passing through said cable pathway.

6. An electrical connector according to claim 3 wherein
said recesses include piercing members to pierce a cable jacket of a cable passing through the cable pathway.

7. An electrical connector according to claim 1 wherein
said strain relief member is fixedly attached to said printed circuit board.

8. An electrical connector according to claim 1 wherein
said strain relief member is free floating relative to said printed circuit board.

9. An electrical connector according to claim 1, wherein
said insulation displacement contacts and said nose contacts are electrically connected by circuit traces formed on said printed circuit board.

10. An electrical connector according to claim 9 wherein
said circuit traces are configured to minimize return loss and near end crosstalk.

11. An electrical connector according to claim 1 wherein
said nose contacts have a generally perpendicularly extending tab for contacting said strain relief member.

12. An electrical connector, comprising:
a housing;
a printed circuit board contained within said housing;
a plurality of insulation displacement contacts mounted on said printed circuit board;
a plurality of nose contacts mounted on said printed circuit board, said nose contacts forming a channel between said nose contacts and said printed circuit board, said nose contacts being electrically connected with said insulation displacement contacts by circuit traces located on said printed circuit board, said circuit traces are configured to minimize return loss and near end crosstalk, and
a relatively rigid strain relief member mounted within said channel formed by said nose contacts and said printed circuit board, said strain relief member abutting said nose contacts.

13. An electrical connector according to claim 12 wherein
said housing comprises a top half and a bottom half, said top half and bottom half being connected by a living hinge.

14. An electrical connector according to claim 13 wherein
said top half and bottom half have recesses forming a cable pathway.

15. An electrical connector according to claim 14 wherein
said recesses are coated with adhesive.

16. An electrical connector according to claim 14 wherein
said recesses form an interference fit with a cable passing through the cable pathway.

17. An electrical connector according to claim 14 wherein
said recesses include piercing members to pierce a cable jacket of a cable passing through the cable pathway.

18. An electrical connector according to claim 12 wherein
said strain relief member is fixedly attached to said printed circuit board.

19. An electrical connector according to claim 12 wherein
said strain relief member is free floating relative to said printed circuit board.

20. An electrical connector according to claim 12 wherein
said nose contacts have a generally perpendicularly extending tab for contacting said strain relief device.

21. An electrical cable for an electrical communications system, comprising:
a cable comprising a plurality of twisted wire pairs extending along a longitudinal axis and a flexible insulating sheath surrounding at least a portion of the plurality of twisted wire pairs; and,
a connector, comprising
a housing;
a printed circuit board contained within said housing;
a plurality of insulation displacement contacts mounted on said printed circuit board, each contact being attached to a wire in said cable;
a plurality of nose contacts mounted on said printed circuit board, said nose contacts forming a channel between said nose contacts and said printed circuit board, said nose contacts being electrically connected to said insulation displacement contacts by circuit traces located on said printed circuit board;
a relatively rigid strain relief member mounted within said channel formed by said nose contacts and said printed circuit board, said strain relief member abutting said nose contacts.
